(19) United States
(12) Patent Application Publication
(10) Pub. No.: US 2018/0315077 A1
(43) Pub. Date: Nov. 1, 2018

(54) MARKETING CONTENT SELECTION AND EXECUTION SYSTEM WITH MULTIVARIATE TESTING

(71) Applicant: SENIORVU, INC., Kansas City, KS (US)

(72) Inventors: Timothy J. Donnelly, Leawood, KS (US); Paul T. Goldman, Augusta, KS (US); Daniel J. Cates, Overland Park, KS (US); Nicholas M. Peeples, Prairie Village, KS (US)

(73) Assignee: SENIORVU, INC., Kansas City, KS (US)

(21) Appl. No.: 15/967,839

(22) Filed: May 1, 2018

Related U.S. Application Data
(60) Provisional application No. 62/492,904, filed on May 1, 2017.

(51) Int. Cl. G06Q 30/02; G06Q 10/06

(52) U.S. Cl. CPC G06Q 30/0244; G06Q 30/0272; G06Q 30/0246; G06Q 10/06398; G06Q 30/0276

(57) ABSTRACT

Systems and methods for selecting, executing and optimizing marketing activities involving marketing content for defined marketing tasks contributed by a plurality of marketing content developers. The system receives multiple versions of the defined marketing task from the plurality of content developers, ranks the content developers in accordance with past performance ratings for similar marketing tasks, allocates shares of the total volume of the marketing activity in accordance with the rankings, executes the marketing activity using the multiple versions of the defined marketing task on a collection of potential customers, scores the performance of each version of the defined marketing task, calculates and stores updated past performance ratings for each content developer based on the scores, and then repeats the process for a series of consecutive execution periods. The system uses multivariate testing to score and optimize the execution of the marketing activity.

### TECHNICAL FIELD

The present invention relates generally to systems and methods acquiring and using marketing content to promote businesses, products and services, and more particularly to automated systems and methods for acquiring, using, testing and optimizing content for defined marketing tasks associated with marketing campaigns and activities.

### BACKGROUND

Businesses use a variety of marketing plans and advertising campaigns to attract and entice potential customers to purchase their products and services. Most marketing plans require creating and using a variety of different classes of marketing content, such as photographs, music, text, graphic designs, web pages, works of art, video clips, audio clips, computer programs (including apps), prints, posters, displays etc. Resource constrained businesses often do not have the budgets required to employ even one full time marketing content developer, let alone an entire staff of marketing content developers. Therefore, such businesses frequently hire outside ad agencies and independent contractors to develop and provide marketing content for proposed marketing plans and activities. But because the cost, aesthetic quality and performance results of marketing content can be so arbitrary, subjective and unpredictable, businesses often must take a leap of faith on a particular content developer, spend potentially thousands, or tens of thousands, of dollars to hire that content developer, and then wait weeks or months before finding out whether the marketing content created and delivered by the content developer meets the specifications of the contract, provides the desired aesthetic qualities, or has any chance of achieving the performance goals for the marketing plan. If the purchased marketing content does not meet or exceed the quality and performance goals of the marketing plan, then businesses frequently must start all over again, using the same arbitrary, subjective, and therefore costly and unreliable, process for acquiring marketing content and executing marketing activities and plans.

Traditional marketing plans use traditional technologies, like photographs, print, text, graphics, music and video to promote products and services over traditional marketing channels, such as radio and television commercials, billboards, kiosks, newspapers and magazines, as well as through direct mail and telephone calls. Digital marketing plans promote products and services using digital technologies and digital channels. Digital marketing may take place using a variety of marketing channels, such as mobile phones and tablets (both SMS and MMS), social media marketing, display advertising, search engine marketing, gaming device marketing, and any other form of digital media, including television and print advertising.

Unfortunately, regardless of whether a marketing plan relies on traditional technologies and marketing channels, digital marketing technologies and channels, or both, there is no quantitative system or method for identifying, acquiring, executing and rigorously testing many important aspects of a proposed marketing plan, and then automatically optimizing the marketing content for the marketing plan to reach more potential customers, achieve better traction with the potential customers exposed to the marketing content, and realize higher rates of success. There is also no objective way to minimize the risks and expenses associated with developing and executing marketing content. As a result, many businesses truly struggle, and ultimately fail, to identify and hire the best content developers for marketing content, and fail to reach their marketing goals.

Consequently, a lot of highly-competitive businesses are constantly searching for more efficient and more cost-effective ways of identifying, selecting, executing, evaluating and optimizing the performance of their marketing activities, and new ways to minimize costly mistakes associated with acquiring and using marketing content developed by independent contractors. What these business need is a data-driven, quantitatively robust system and method that they can use to automatically acquire the best, high quality marketing content for a marketing activity or marketing plan. There is also substantial need for a system and method for scoring and evaluating a multiplicity of different versions of a defined marketing task created and contributed by a multiplicity of different marketing content developers, and for rigorously testing the multiple versions of a marketing task against each other, and scoring the versions of the marketing tasks based on the responses of real potential customers.

### DISCLOSURE OF THE INVENTION

Embodiments of the present invention address the above-described needs by providing a computer-implemented system that automatically solicits, receives and selects content for marketing tasks associated with a marketing activity, executes the marketing activity using the selected content, and automatically allocates a proportion of the total volume of the marketing activity based on performance ratings of the content developers on earlier projects. The system may be used by a variety of different types of business operators seeking to promote their products and services, including without limitation, operators of senior living communities, hotels, restaurants and entertainment complexes, to name but a few illustrative examples. The system is configured to solicit and receive multiple versions of a defined marketing task from multiple content contributors. For example, if the marketing task comprises creating and sending out 1000 email solicitations to a collection of potential customers for the business, then each version of the email solicitation developed and contributed by multiple content developers could, and probably would, include creative elements, such as photos, graphics, text, audio clips and video clips, that are at least somewhat different from each other, depending, for example, on each content developer's level of skill and experience with the particular subject matter or the particular specifications for the marketing task.

Before executing the marketing activity (e.g., sending out marketing emails containing the solicited marketing content), the system automatically ranks the multiple content developers in accordance with past performance ratings for similar marketing content (i.e., marketing content considered to fall within the same category or classification). The system then automatically allocates shares of the total volume of the marketing activity (1000 emails, for example) to each content developer in accordance with the content developers' rankings. For example, in a first round of executing the marketing activity over a defined period, the version of the marketing task contributed by the best ranked content developer (based on past performance ratings of the content developer for similar marketing tasks) will receive the largest share of the total volume of the marketing activity when the marketing activity is executed. The version of the marketing task contributed by the second best ranked content developer (based on past performance ratings for the second best ranked contributor on similar marketing tasks) will receive the second largest share of the total volume of the marketing activity, and so on. The system then automatically executes a second round of marketing activity (e.g., transmits the emails) for a first collection of potential customers (in accordance with the share allocations) over the defined marketing period. The defined marketing period may comprise any length of time appropriate for executing and fairly evaluating the impact of a marketing activity. So the defined marketing period may comprise, for example, a week, or a month, or a year, for instance, depending on the particular marketing activity.

During (or at the end) of the defined marketing period, the system automatically monitors and scores the performance of each version of the marketing task in terms of their rates of success or failure based on a specified success or failure criteria comprising a variety of different factors (multivariate testing). The scores achieved by each version of the executed marketing task are then stored and used by the system to generate new (or updated) past performance ratings (and rankings) for each content developer. The system then uses the new rankings to re-allocate shares of the total volume of the marketing activity. The multiple versions of the marketing task (with a potentially different allocation of the shares of the total volume for the marketing activity) are then used by the system in a second execution of the marketing activity against a second collection of potential customers over a second defined marketing period to assess and score the performance of each version of the marketing task on the second collection of potential customers. The system automatically scores the performances of the multiple versions of the marketing task for the second defined marketing period to calculate updated past performance ratings for the content developers, to again rank the contributing content developers, and to re-allocate shares of the total volume of the marketing activity to be executed on yet a third collection of potential customers over a third defined marketing period.

As will be explained in more detail below, the allocation of shares for the executions of the marketing activity in any given round of execution may be accomplished in a variety of different ways. For example, the allocation of shares may be accomplished by first weighting each version of the marketing task based on the past performance ratings of the contributors, and then using a random number generator to select which versions of the marketing task will be executed in each round of execution (assuming there are multiple execution rounds), thereby pseudo-randomizing the selection of marketing tasks that will be executed and scored for performance in each execution round. The weighting and pseudo-random selection of marketing tasks versions provides an opportunity for any version of the marketing task to be selected and used in any round of execution (regardless of past performance rating). Over time and over multiple executions of the marketing activity, however, the content developers with the best past performance ratings will typically have an advantage over other content developers in that their versions are more likely to be picked for any given round of execution.

Alternatively, the allocations of shares for the total volume of the marketing activity to be executed could be arbitrarily defined by the business or system operator (e.g., the best ranked content developer receives 50% of the total volume, the second best ranked content developer receives 30% of the total volume, and the third best ranked content developer receives 20% of the total volume) without departing from the scope of the claimed invention. In still other embodiments, the versions of the defined marketing task selected for execution and testing in any given round of execution could be selected in round-robin fashion.

The process of scoring the performance of each version of the marketing task, updating past performance ratings of content developers based on the current scores and past performance ratings, ranking the content developers based on updated past performance ratings, allocating shares of the total volume of the marketing activity in accordance with the updated rankings, and executing and scoring multiple versions of the marketing task against new collections of potential customers are automatically repeated by the system indefinitely, or may be limited to a certain number of defined marketing periods (e.g., six times in each of six months). The overall effect is that the system ensures that the best opportunity to “win” the a marketing task will be given most often to those contributors who have historically performed the best (received the highest scores) on similar marketing tasks, while also ensuring that those contributors who have achieved lower performance ratings, and new contributors who have never contributed marketing content before, also have a reasonable opportunity (over a period of time) to win larger shares of the total volume of the marketing activity, despite starting out with low or no performance ratings for similar marketing tasks.

Accordingly, in one aspect of the present invention, there is provided a system for selecting and testing marketing content for a business, comprising a microprocessor, a memory storage area, a business interface for receiving and storing a set of business attributes for the business, and a marketing plan dataset having records defining a marketing objective and a marketing activity for the marketing plan, a total volume and a time limit for the marketing activity, a defined marketing task for the marketing activity, and a classification for the defined marketing task. The system further comprises a content developer interface for receiving multiple versions of the defined marketing task submitted by multiple content developers, respectively, and a past performance calculator to calculate, for each content developer among said multiple content developers, a past performance rating for a previous marketing task having the same classification as the defined marketing task. A leads interface receives and stores a collection of potential customer leads, and a marketing plan execution module has program instructions that, when executed by the microprocessor, will cause the microprocessor to automatically:

1) rank the plurality of content developers who have submitted versions of the defined marketing task based on the past performance ratings for each content developer in the plurality of content developers,

2) allocate shares of the total volume of the defined marketing activity in accordance with the ranks of the multiple content developers so that the largest share of the total volume of the marketing activity is filled by a version of the defined marketing task contributed by a content developer with the best ranking, and the second largest share of the total volume of the marketing activity will be filled by a version of the defined marketing task contributed by a content developer with the second best ranking,

3) execute the marketing activity against the collection of potential customer leads using said allocation of shares for the multiple versions of the defined marketing task,

4) track and record responses and non-responses to the executed marketing activity by the collection of customer leads,

5) assign scores to the versions of the defined marketing task used to execute the marketing activity based on a predefined success or failure criterion for the recorded responses and non-responses,

6) invoke the past performance calculator to modify or adjust the past performance ratings for each content developer in the plurality of content developers based on the scores assigned to each version of the defined marketing task used in the execution of the marketing activity,

7) invoke the leads interface to modify the collection of potential customer leads, and

8) repeat steps 1 through 7 until a specified marketing objective for the marketing plan is met, or a specified time limit for the marketing activity expires.

In another aspect of the present invention, there is provided a method for selecting and testing marketing content for a marketing plan using a microprocessor and a memory storage area, the method comprising the steps of:

(A) receiving and storing in the memory storage area a set of business attributes for the business;

(B) storing in the memory storage area records defining a marketing objective and a marketing activity for the marketing plan, a total volume and a time limit for the marketing activity, a defined marketing task for the marketing activity, and a classification for the defined marketing task;

(C) receiving and storing in the memory storage area multiple versions of the defined marketing task submitted by multiple content developers, respectively;

(D) calculating with the microprocessor, for each content developer among said multiple content developers, a past performance rating for a previous marketing task having the same classification as said defined marketing task;

(E) receiving and storing in the memory storage area a collection of potential customer leads;

(F) with the microprocessor, ranking the plurality of content developers who have submitted versions of the defined marketing task based on the past performance ratings for each content developer in said plurality of content developers;

(G) with the microprocessor, allocating shares of the total volume of the defined marketing activity in accordance with the rankings for said multiple content developers so that the largest share of the total volume of the marketing activity is filled by a version of the defined marketing task contributed by a content developer with the best ranking, and the second largest share of the total volume of the marketing activity will be filled by a version of the defined marketing task contributed by a content developer with the second best ranking;

(H) with the microprocessor, causing the marketing activity to be executed against the collection of customer leads using said allocation of shares for the multiple versions of the defined marketing task;

(I) with the microprocessor, tracking and recording in the memory storage area responses and non-responses to the executed marketing activity by the collection of customer leads;

(J) with the microprocessor, assigning scores to the versions of the defined marketing task used to execute the marketing activity based on a predefined success or failure criterion for the recorded responses and non-responses,

(K) with the microprocessor, modifying the past performance ratings for each content developer in the plurality of content developers based on the scores assigned to each version of the defined marketing task used in the execution of the marketing activity,

(L) with the microprocessor, modifying the collection of potential customer leads, and

(M) repeating steps (F) through (L) until the specified marketing objective for the marketing plan is met or the specified time limit for the marketing activity expires.

### BRIEF DESCRIPTION OF THE DRAWINGS

FIG. 1 shows a high-level diagram illustrating a marketing dataset and the relationships between marketing plans, marketing campaigns, marketing activities and marketing tasks in a marketing dataset, in accordance with one embodiment of the invention.

FIG. 2 shows a high-level block diagram of an exemplary computer network, which includes a marketing content selection and execution system configured to operate according to one implementation of the present invention.

FIGS. 3 and 4 show a high-level flow diagram illustrating by way of example the steps performed in one implementation of the invention, such as the computer implementation depicted in FIG. 2, wherein the business is a senior living community and the shares of the total volume of the marketing task are allocated in accordance with a defined set of percentage portions provided by the senior living community or system operator.

FIG. 5 shows a high-level flow diagram illustrating by way of example the steps performed in an alternative implementation of the invention, wherein weighting of marketing tasks and a random number generator are used to allocate and execute multiple versions of a defined marketing task.

FIG. 6 shows examples of business attributes for a senior living community in one implementation of the invention.

FIG. 7 shows examples of business attributes for a hotel in one implementation of the invention.

FIG. 8 shows examples of business attributes for a restaurant in one implementation of the invention.

FIG. 9 shows examples of business attributes for an entertainment complex in one implementation of the invention.

### DETAILED DESCRIPTION OF EXEMPLARY EMBODIMENTS

Embodiments of the present invention provide computer-implemented systems and methods that use past performance ratings and multivariate testing to help business operators identify, select and use marketing content for defined marketing tasks associated with a marketing plan, marketing campaign or marketing activity. The system essentially invites content developers to use their personal knowledge, skill, creativity and experience to create and contribute their own versions of a marketing task, receives multiple versions of the marketing task from multiple content developers, ranks the content developers in accordance with past performance ratings for similar marketing tasks, allocates shares of the total volume of the marketing activity in accordance with the rankings, executes the multiple versions of the marketing task during a defined execution period, scores the performance of each version, calculates updated performance ratings for each content developer based on the scores, and then repeats the process for a series of consecutive defined execution periods.

Thus, the system is configured to receive and store multiple versions of defined marketing tasks from multiple content developers. The system automatically executes the multiple versions of the marketing tasks by, for example, transmitting, displaying or otherwise presenting the multiple versions of the marketing task to a collection of potential customers for a defined execution period. There are multiple versions of the marketing tasks because each content developer provides his or her own version of the marketing task, which may differ in some creative fashion from every other version of the marketing task supplied by every other content developer. For example, if the marketing activity is to send out emails, and the marketing task for the marketing activity is to create a subject line or graphic image for the email, each one of the content developers who contributes one of the marketing tasks could, and probably would, create a unique version of the subject line or graphic image for the email, depending on the content developer's level of skill and experience. In fact, each content developer could be encouraged to create and contribute a unique version of the marketing task so that a wide range of versions of the marketing tasks can be executed and tested against the collection of potential customers. Each version of the marketing task will therefore possess a unique aesthetic and could thereby provide a unique user experience for potential customers, which could in turn provoke different responses (or non-responses) from the potential customers, depending on their user experiences with the unique marketing tasks. These different responses (or non-responses) from the recipients of the marketing tasks are monitored and tracked by the system, and used by the system to score the level of performance for each version of the marketing task. More specifically, the system automatically monitors the success or failure of each version of the marketing task, based on a specified or predefined success or failure criteria, to produce a score for each version of the marketing task. The system then uses the scores for each version of the marketing task, along with data about the nature of the marketing task, to calculate and record in a database a past performance rating for each content developer who contributed a version of the marketing task used in the execution of the marketing task over the defined execution period.

Subsequently, when another marketing activity arises, which calls for completing the same or a similar marketing task, the system of the present invention may be configured to automatically create and broadcast to content developers a request for contributions of marketing content that meets or satisfies the parameters of the newly arisen marketing task (which is now the current marketing task). When two or more content developers respond to the request for the current marketing task by submitting two or more versions of the marketing task, respectively, the system automatically retrieves from the database the past performance ratings for each one of the contributing content developers on previously submitted and executed marketing tasks that are similar in nature (or a similar in type or subject matter) to the current marketing task. The system then uses the past performance ratings for each content developer to rank each content developer that contributes a version of the current marketing task. The system then uses these content developer rankings to determine and allocate shares of the total volume of the current marketing activity to be executed against a new collection of potential customers over a defined execution period for the current marketing task.

More specifically, for each content developer who contributes a version of the current marketing task in response to the request for contributions of the current marketing task, the system will automatically determine whether that content developer has a past performance rating for previously submitted marketing tasks of a similar nature. The system will then determine a ranked order for all the content developers for the current marketing task based on the past performance ratings for those content developers. After the system determines the rank order of the contributing content developers, the system next allocates the total volume of the current marketing activity in accordance with the rank order. In other words, the version of the current marketing task contributed by the best ranked contributor (based on past performance ratings for similar marketing tasks) will receive the largest share of the total volume of the current marketing activity when the current marketing activity is executed. The version of the current marketing task contributed by the second best ranked contributor (based on the past performance ratings for similar marketing tasks) will receive the second largest share of the total volume of the current marketing activity when the new marketing task is executed, and so on.

When the current marketing activity is executed, it will contain multiple versions of the current marketing task created by multiple contributors, respectively. In some embodiments, the system may be configured to use a version of the current marketing task from every contributor (i.e., every version of the current marketing task that the system receives before the beginning of the defined execution period). In other embodiments, the system may be configured to use a limited number of versions (e.g., five versions supplied by the top five contributors based on past performance ratings). The system is also configured to calculate and record a performance score for each version of the current marketing task based on a predefined multiplicity of variables indicative of success or failure for the marketing task (i.e., multivariate testing). The multivariate testing variables may be provided by the system operator and/or the business for which the marketing content for the current marketing task is requested.

In general, the performance score for a version of a current marketing task comprises a measure of the version's success or failure relative to the success or failure of other versions of the current marketing task executed during the same defined execution period. Success criteria may include, for example, a set of specified minimum values for the number of times during the defined execution period that person in the collection of potential customers contacts the business, or clicks on an emailed link, or fills out a form, or subscribes to a marketing content distribution list, or purchases a product or service, or signs up for a tour, a meeting or a demonstration, or otherwise expresses or manifests a positive response to receiving the executed marketing task. Failure criteria may include, for example, a set of specified maximum values for the number of times during the defined execution period that person in the collection of potential customers deletes and email without reading it, unsubscribes from a marketing content distribution list, cancels a product or service, or otherwise expresses or manifests a negative response to receiving the executed marketing task. Embodiments of the present invention may then calculate and assign scores to each version of the marketing task by awarding to each version of the marketing task a specified number of points for every positive response from a potential customer and/or deducting a specified number of points for every negative response (or non-response) received from a potential customer. The system records the nature of the current marketing task, as well as the performance scores (i.e., the success or failure measures) for each one of the multiple versions of the current marketing task, in a content developer dataset located on or connected to the system.

A marketing plan may call for executing the current marketing task multiple times over the course of multiple defined execution periods, respectively. For example, the marketing plan could call for executing (e.g., transmitting) the marketing content for a marketing task at the beginning of every week over the course of an eight-week span of time. In this scenario, the first week is the first defined execution period for the current marketing task, the second week is the second defined execution period for the current marketing task, the third week is the third defined execution period for the current marketing task, and so on. At the end of the first week (i.e., at end of the first defined execution period and before the beginning of the second defined execution period), the system automatically adjusts the past performance ratings of each one of the content developers who contributed a version of the current marketing task based on the performance score for each content developer's version of the current marketing task, respectively, during the first week. In other words, the system uses the performance scores from the first week, along with the scores received by the content developers on any similar previously executed marketing tasks to calculate a new performance rating for each one of the content developers.

Then the system uses the adjusted performance ratings of the participating content developers to re-rank the content developers to re-allocate shares of the total volume of the current marketing activity to execute during the second week (i.e., the second defined execution period) for the marketing task. Suitably, the process of executing and scoring multiple versions of the current marketing task over the course of multiple defined execution periods, and adjusting the past performance ratings of each content developer, re-ranking the content developers based on the adjusted past performance ratings, and re-allocating shares of the total volume of the current marketing activity based on the adjusted content developer rankings prior to the beginning of each one of the defined execution periods based on the scores achieved by each version of the current marketing task during the previous defined execution period, is repeated for each one of the multiple defined execution periods. The overall effect is to ensure that, at the beginning of the first defined execution period (e.g., the beginning of the marketing plan), when a new marketing task is selected for execution, the system automatically grants the best opportunity to dominate the total volume of the current marketing activity to those content developers who have achieved the best past performance ratings for similar marketing tasks, while also ensuring that over the course of multiple defined execution periods, new content developers and those content developers who have only achieved lower performance ratings for similar marketing tasks also have a decent opportunity to eventually dominate the total volume of the marketing activity, despite starting out with a lower past performance rating for similar marketing tasks.

As an illustration, suppose, for example, that a new marketing task for a marketing plan requires sending out 1000 emails of marketing material to 1000 new leads (i.e., potential customers) in week 1 of a marketing campaign, sending out 1000 additional emails to 1000 additional new leads in week 2 of the campaign, and then sending out 1000 more emails to 1000 more new leads in week 3 of the campaign. The system and method of the present invention may be configured to automatically invite a multiplicity of content developers to develop, create and contribute their own unique versions of the email marketing content to be considered and possibly used for the email marketing task. Each version of the email marketing task received from a contributor is probably creatively and/or aesthetically unique in some fashion from every other version of the email. For example, each version could have a slightly different subject line, a unique embedded image, a unique sound or video clip, a unique arrangement of icons, colors and buttons for the reader to select from, a unique response to the user clicking on an icon or button, etc.

Suppose further that, for this marketing plan and marketing task, the system is configured to limit participation to the top four content developer contributors based on past performance ratings for similar email tasks. As the system receives different versions of the email marketing task from multiple (and possibly thousands of) content developer contributors, the system retrieves, from a contributor dataset, the past performance ratings for every content developer contributor who contributes a version for this email marketing task. Suppose further that, for the new marketing task, the system is configured to allocate 50% of the total volume of new emails that will go out in week 1 to the content developer contributor with the best past performance rating for similar emails; 30% of the total volume of new emails in week 1 to the content developer contributor with the second best past performance rating for similar emails; 15% of the total volume of new emails to the content developer contributor with the third best past performance rating for similar emails, and allocate the remaining 5% of the total volume of new emails to the content developer contributor with the fourth best past performance rating for similar emails. Suppose even further that the top four contributors (based on past performance ratings for similar emails) are Contributors A, B, C and D. It is understood that many more contributors with lower past performance ratings may have contributed their own versions of the new email marketing task, but those contributors may not be allowed to participate because they have not previously provided similar emails that, after scoring, caused those contributors to be classified as one of the top four most successful contributors for similar emails. It is also understood that some contributors (e.g., Contributor E) may have achieved higher performance ratings than Contributors A, B, C and D for similar emails, but Contributor E may have failed, for one reason or another, to submit a contribution for the email marketing task in time for Contributor E's version of the email marketing task to be considered and used in the collection of emails that must go out during week 1.

The top four contributors who submitted versions in time to use in the week 1 mailings are then ranked in accordance with their past performance ratings for similar marketing tasks, and assigned a share of the total volume of new emails for week 1 in accordance with their rankings. Since the total volume of emails that will be sent out in week 1 is 1000 emails, then 500 (50%) of the 1000 emails sent in the first week will contain the version of the email contributed by Contributor A, 300 (30%) of the 1000 emails sent in the first week will contain the version of the email contributed by Contributor B, 150 (15%) of the 1000 emails sent in the first week will contain the version of the email contributed by Contributor C, and 50 (5%) of the 1000 emails sent in the first week will contain the version of the email contributed by Contributor D. The shares of the total volume of emails sent out in week 1 are shown in the second column of Table 1 below:

TABLE 1
Contributor Shares for Week 1

| Estimated No. | |
|---|---|
| of Emails | Week 1 |
| (Out of 1000) | Contributor |
| 500 | A |
| 300 | B |
| 150 | C |
| 50 | D |

After the first 1000 emails are sent out in week 1, the system receives, tracks and scores the performance of each version of the email task, and updates the performance ratings of the various contributors based on the scores from week 1. As previously stated, scoring may be based on a large variety of actions, responses or results, including for example, the number of times the email is opened by a recipient, the number of times the business (or system operator) receives a response to the email, the number times the email is forwarded, the number times the email is deleted without being read, whether the email is cited by a visitor to the business as the reason for the visit, whether a form was filled out, whether a purchase or rental of a product or service can be traced back to the email, etc. These performance scores for each version of the email marketing task are recorded by the system and used to calculate and adjust each contributor's past performance rating for email tasks like the current email task. Thus, a contributor's performance rating for a given type of task can change from week to week depending on the relative success or failure (i.e., the current scores) of the content developers' versions of the new email task and the corresponding adjustments to the past performance ratings of the content developers resulting from incorporating the current performance scores.

For instance, if it is determined after week 1 that the versions of the new email task contributed by Contributors B and D received a much more favorable response, and therefore much higher scores, than the versions of the email task contributed by Contributors A and C, then the resulting adjustments to the performance ratings of all four of the contributors (based on the scores received for the week 1 mailings) could change the overall past performance rankings of the four contributors such that the allocation of shares of the total volume of emails that go out in week 2 is significantly different from the allocation of shares of the total volume of emails that went out in week 1. Thus, in week 2, Contributors B and D may be ranked higher than Contributors A and C, causing the shares to be distributed as shown the third column of table 2 below. As shown in table 2 below, during the defined execution period of week 2, Contributor B's version of the email task (instead of Contributor A's version of the email task) is used for 500 (or 50%) of the total volume of 1000 emails sent out in week 2, Contributor D's version of the email task (instead of Contributor B's version) is used for 300 (or 30%) of the total volume of 1000 emails sent out in week 2, Contributor A's version of the email task (instead of Contributor C's version) is used for 150 (or 15%) of the total volume of 1000 emails sent out in week 2, and Contributor C's version of the email task (instead of Contributor D's version) is used for 50 (or 5%) of the total volume of 1000 emails sent out in week 2.

TABLE 2
Contributor Shares for Week 2

| Estimated No. | | |
|---|---|---|
| of Emails | Week 1 | Week 2 |
| (Out of 1000) | Contributor | Contributor |
| 500 | A | B |
| 300 | B | D |
| 150 | C | A |
| 50 | D | C |

In week 3, the calculation of the performance rating for each contributor in the contributor database will include the scores for the versions of the email task that went out in both weeks 1 and 2, and the allocation of the shares of the total volume of 1000 emails that go out in week 3 will be adjusted in accordance with the rankings of the contributors based on their overall past performance rating at the beginning of week 3. However, other intervening events could also change the allocation of shares of the total volume of emails that go out in week 3. Suppose for example, that between week 2 and week 3, Contributor E, who has a past performance rating that far exceeds the past performance ratings of all the other contributors for similar email tasks, finally submits her own version of the current email marketing task. Because Contributor E has consistently come in as the top performer for similar email tasks, her late participation effectively bumps Contributor C out of participation in week 3, which might result in a completely different allocation of shares in week 3, as illustrated by the letters in the fourth column of Table 3 below.

TABLE 3
Contributor Shares for Week 3

| Estimated No. | | | |
|---|---|---|---|
| of Emails | Week 1 | Week 2 | Week 3 |
| (Out of 1000) | Contributor | Contributor | Contributor |
| 500 | A | B | E |
| 300 | B | D | B |
| 150 | C | A | D |
| 50 | D | C | A |

The adjustments to the scores, the past performance ratings, the rankings and the shares of the total volume of emails to go out in successive executions of the current marketing task may be repeated indefinitely until the final defined execution period (e.g., the final week, the final month, etc.) of the marketing campaign.

One of the benefits of assigning the largest share of the total volume of emails in any particular execution of the task to the contributor with the most success historically, while also assigning at least a portion of the total volume to other contributors with relatively lower ratings (or no ratings at all) is that it tends to reveal the best content for certain tasks more quickly (based on past performance) without forcing businesses to rely solely on past performance. As the saying goes, everybody has a bad day at least occasionally. Therefore, a historically excellent performer could, on occasion, contribute a piece of work that falls far short of expectation, or otherwise fails to rise to the top of the class when compared to all the other submissions for the same task. By the same token, content contributors who have lower historical performance ratings (or no historical performance ratings at all) still have a decent opportunity to experience the marketing equivalent of hitting a home run on any particular marketing task because embodiments of the present invention permit historically lower performing contributors to participate to some extent by getting a share of the total volume in the execution of the activity in accordance with performance of each version of the task over a defined length of time (e.g., 4 weeks, 4 months or 4 years). With the present invention, the version of the task that consistently gets the best scores in multiple executions of the task (regardless of the contributor's initial rank) will, if given enough time and enough executions, eventually “win” the largest share of the total volume for the marketing activity. This means, of course, that the marketing material with the best results eventually gets the most use, which is exactly what the business desires for the marketing plan.

Preferably, but not necessarily, the past performance ratings of the contributors may be based in part on the contributors' past performance on similar tasks for businesses with the same or similar business attributes as the business in question. Thus, if the marketing task to be performed will be performed on behalf of a business having certain business attributes, then the system of the present invention will automatically select and use the past performance ratings associated with marketing tasks performed for a businesses with the same or similar business attributes.

For example, if the business is a senior living community having a geographic location in the State of Missouri, a golf course, five restaurants, many veterans, and/or residents with extremely high net worth, then the system of the present invention will automatically select and use the past performance ratings of content developers on tasks executed for senior living communities with the same or similar community attributes. Consequently, a contributor with a stellar performance rating on an email marketing task that was previously executed on behalf of relatively large senior living community that provides assisted care to relatively wealthy residents located in New York City will not necessarily be assigned a large portion of the total volume of emails for an email marketing task that will be executed on behalf of a small senior living community that provides only memory care for relatively low net-worth residents located in Los Angeles.

In other words, the system may be configured so that the success metrics for contributors are not merely measures of past performance on similar tasks, but measures of how the contributors performed on similar tasks for businesses with the same attributes as the current business. Therefore, if a contributor's past performance rating for a previously-used marketing task is to be considered for purposes of allocating a share of the total volume of a new marketing activity, then the system automatically selects and uses the past performance ratings for content developers who have created content for businesses having business attributes like the business attributes of the current business. Selecting contributors based on their past performance ratings on content created for similar tasks for businesses with similar attributes may be considered a significant benefit to some businesses.

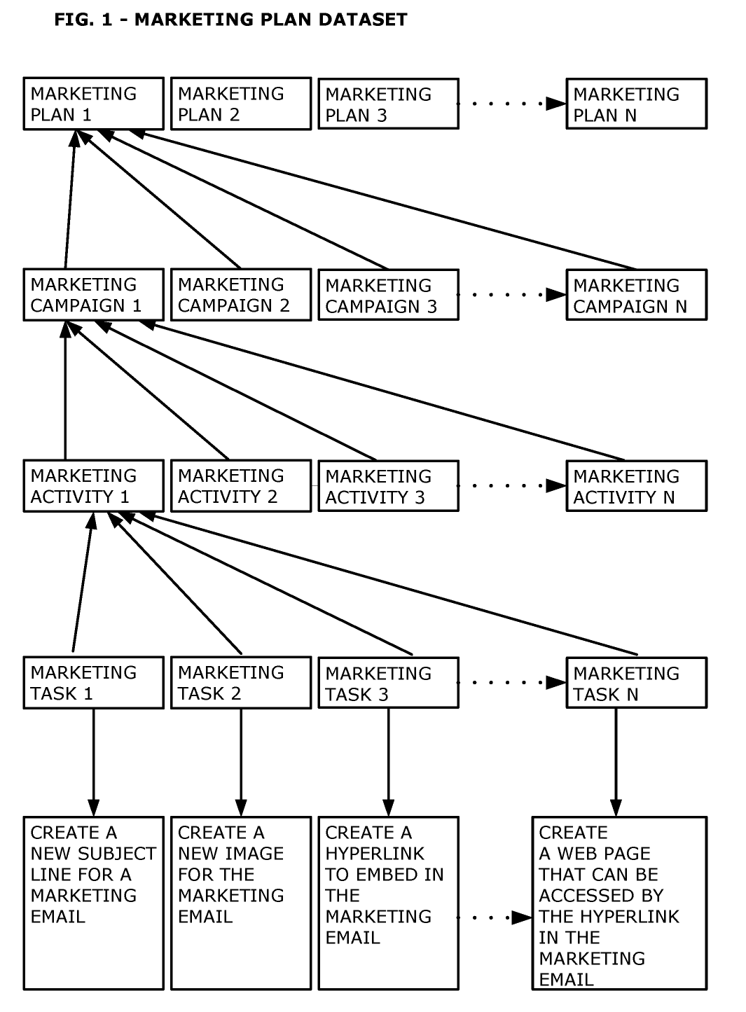

Turning now to the figures, FIG. 1 shows a high-level diagram illustrating by way of example the relationships between marketing datasets, marketing plans, marketing campaigns, marketing activities and marketing tasks. FIG. 1 also provides specific examples of marketing tasks that might be associated with a marketing activity of sending out a collection of marketing emails.

A marketing plan data set comprises a data structure located in a memory storage area of a computer system, which is configured to hold data associated with one or more marketing plans for a business. As shown in FIG. 1, a marketing dataset may comprise any number up to a multiplicity of different marketing plans 1-N for a business. Each marketing plan 1-N may in turn include any number up to multiplicity of different marketing campaigns 1-N associated with a particular marketing plan, and each one of the marketing campaigns 1-N may comprise any number up to a multiplicity of different marketing activities 1-N associated with a particular marketing campaign. And finally, and each one of the marketing activities 1-N may comprise any number up to a multiplicity of different marketing tasks 1-N associated with a particular marketing activity for a particular marketing campaign of a particular marketing plan.

A marketing plan may be described as any plan, information, document, proposal or strategy designed to help a business make the best use of its resources to achieve sales and growth objectives, or increase company or product recognition and awareness. Typically, a marketing plan outlines marketing campaigns and marketing activities for a business for a set time frame. The marketing plan may also propose and describe business activities designed to accomplish specific marketing objectives within the set time frame. The marketing plan may also include a description of the current marketing position of a business, a discussion of the target market, budgets, sales forecasts, strategies, projected financial statements, and a description of the mix of marketing campaigns, marketing activities and marketing tasks that a business will use to achieve its marketing goals during the specified time frame. For example, a marketing plan may include a strategy to increase the business's market share by fifteen percent. The marketing plan would then outline the marketing campaigns, marketing activities and marketing tasks that need to be implemented by the business to reach the fifteen percent increase in the business market share.

A marketing campaign typically comprises a specific message, theme or idea to be conveyed to potential customers (usually via a variety of different marketing channels) to promote the products or services of a business, or to increase brand or company awareness and recognition among potential customers. Examples of famous marketing campaigns include, for instance, the “Just Do It” campaign by Nike, the “Where's the Beef” campaign by Wendy's, and the “Can You Hear Me Now” test man campaign by Verizon Wireless. Marketing activities may include, for example, making and broadcasting radio and television commercials promoting a business' products and services, sending out emails containing newsletters or articles that promote a business' products or services, creating a website and taking steps to ensure that the new website is always among the top results on search engines (search engine marketing), placing a business' products or services on outdoor media (billboards) or in a movie or video game, or telemarketing to potential customers.

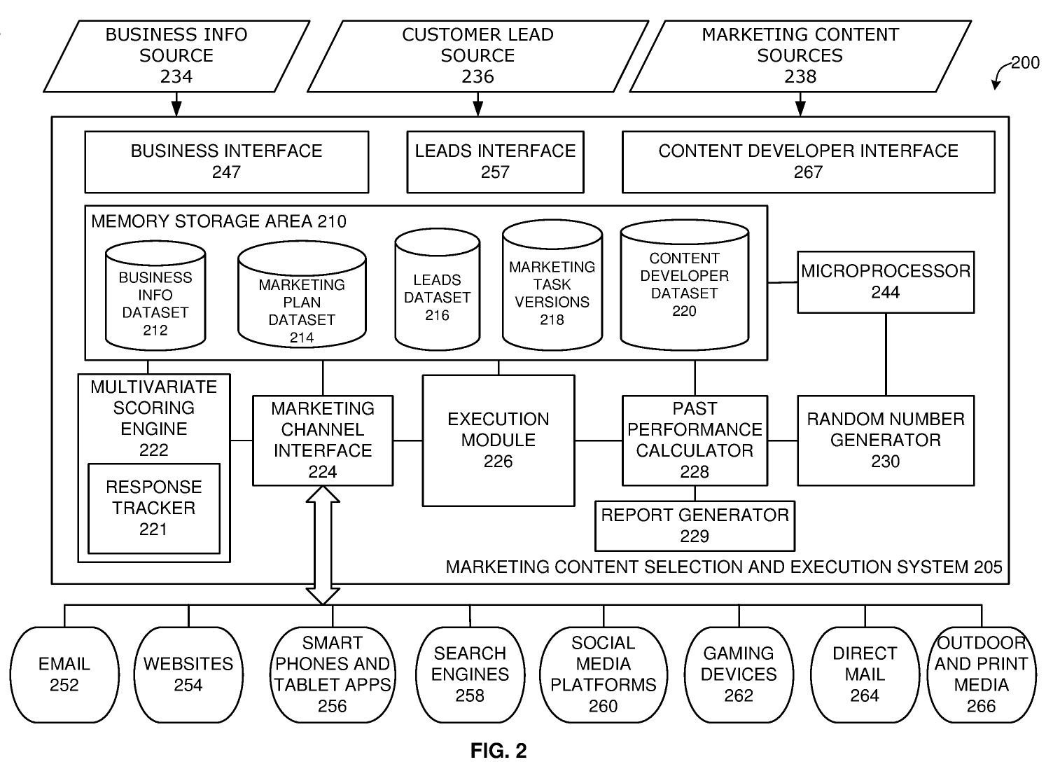

Marketing tasks may include any or all the specific tasks that need to be completed to carry out a marketing activity for a marketing campaign comprising part of a marketing plan. For example, if the marketing activity is to send out emails promoting products or services, then the marketing tasks associated with such a marketing activity could include, for example, creating a new subject line for the marketing email, creating a new image for the marketing email, creating a hyperlink to embed in the marketing email, and/or creating a new web page that can be accessed by the hyperlink embedded in the marketing email. Each one of these marketing tasks may be performed by one or more of the content developers whose contact information and past performance ratings are stored in the content developer dataset 220 of the marketing content selection and execution system 205 depicted in FIG. 2.

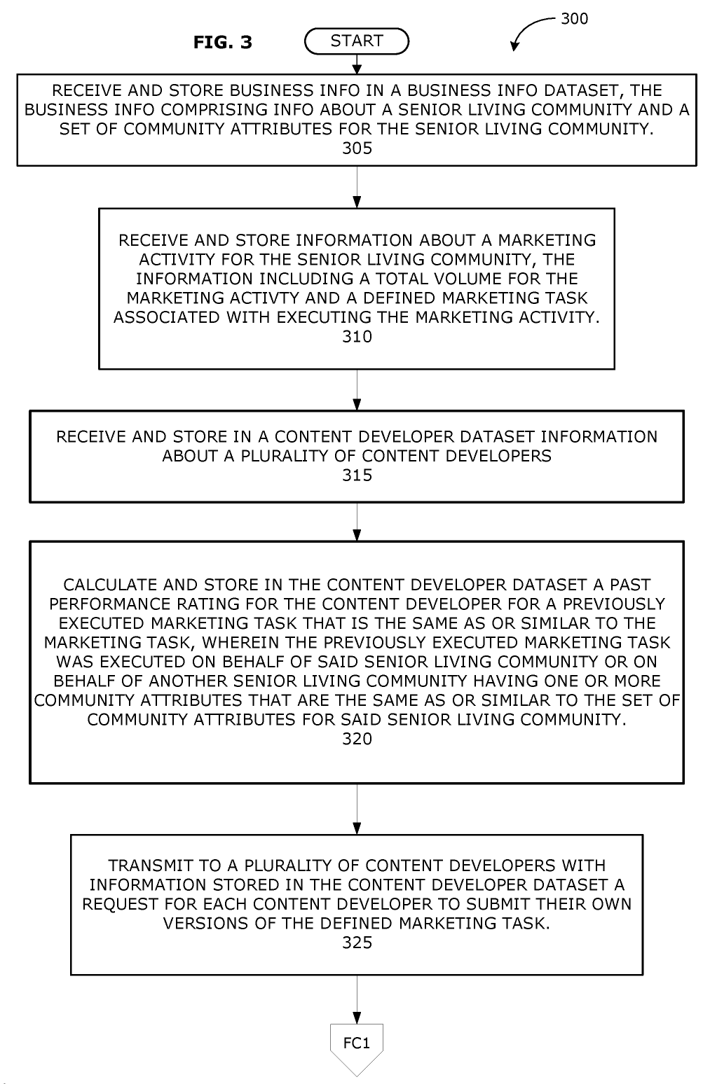

FIG. 2 shows a high-level block diagram of an exemplary computer network 200, which includes a marketing content selection and execution system 205 configured to operate according to one implementation of the present invention. As shown in FIG. 2, the marketing content selection and execution system 205 typically includes a microprocessor 244, a memory storage area 210 configured to store any number of datasets to be used by the system to solicit, receive, select, execute and test marketing tasks, including a dataset of business info dataset 212, a marketing plan dataset 214, a leads dataset 216, a dataset of marketing task versions 218 and a content developer dataset 220. The marketing content selection and execution system 205 also includes a collection of computer programs or modules, located in volatile memory storage area (or random-access memory), the programs or modules each comprising programming instructions that, when executed by the microprocessor 244, causes the microprocessor 244 to carry out the functions of the system 205 in accordance with the exemplary flow diagrams depicted in FIGS. 3, 4 and 5, which are described in more detail below. For the sake of clarity, the volatile memory storage area (random access memory) is not shown in FIG. 2.

In this case, the collection of computer programs or modules includes a response tracker 221 for monitoring and tracking responses (or non-responses) to each version of the defined marketing task, and multivariate scoring engine 222 that calculates and scores each version of the defined marketing task based on the performance (e.g., the level of success or failure) of each version of the defined marketing tasks. The multivariate scoring engine 222 scores each version of the defined marketing task based on a combination of multiple variables associated with the responses and non-responses, such as the number of click-throughs, telephone calls, website visits, purchases or rentals of products or services received from potential customers, etc., which are attributable to the version of the defined marketing task. A marketing channel interface 224 is responsible for communicating marketing tasks to one or more marketing channels, an execution module 226 for automatically triggering the execution of the marketing activity using the allocated versions of the defined marketing task, monitoring and scoring of multiple versions of a marketing task, a past performance calculator 228 that automatically calculates and adjusts past performance ratings for content developers based on scores produced by the multivariate scoring engine 222, and a random number generator, which automatically generates random numbers to be used by the marketing activity execution module 226, in conjunction with the past performance ratings stored in the content developer profiles dataset 220, for selecting and executing multiple versions of specified marketing tasks stored in the dataset of marketing task versions 218.

The marketing channel interface 224 is configured to communicate multiple versions of marketing tasks from the dataset of marketing tasks versions 218 to the appropriate marketing channel over a data communications network. For example, if the multiple versions of marketing tasks comprises sending out multiple emails created by multiple content developers, then the program instructions in the marketing activity execution module 226 would cause the microprocessor 244 to retrieve the multiple versions of the marketing tasks from the dataset of marketing tasks versions 218 in the memory storage area 210 and send the multiple versions out to the email channel 252 of potential customers via the marketing channel interface 224. The other marketing channels connected to the marketing channel interface 225 may include, without limitation, a website channel 254, a smart phones and tablet apps channel 256, a search engine channel 258, a social media platforms channel 260, a gaming devices channel 262, a direct mail channel 264 and an outdoor and print media channel 266.

Suitably, in preferred embodiments, the marketing content selection and execution system 205 also comprises several user interfaces for receiving data, leads and marketing content. These user interfaces include a business interface 247 for receiving pertinent business info (e.g., business identifiers and business attributes) from one or more business info sources 234, such as a business or system operator, and storing the business info in the business info dataset 212; a leads interface 257 configured to receive information about potential customers (e.g., potential customer email addresses) from one or more customer lead sources 236, such as a lead generating system, and storing the potential customer leads in the leads dataset 216, and a content developer user interface 267 configured to receive versions of marketing content from one or more marketing content sources 238, such as content developers and outside ad agencies, and store the versions of marketing content in the dataset of marketing task versions 218. The business interface 247 may also be used by system and industry experts acting as advisors or consultants to the business using the system to execute, test and optimize marketing activities involving multiple defined marketing tasks. Such expert advisors and consultants may help users select new marketing tasks based on special knowledge and experience in the marketing field, and also help users understand what effect certain changes in the marketing activities will have on the business. A report generator 229 is also provided to permit users to print and review reports showing historical or real-time progress resulting from changes in marketing content from one execution round to the next.

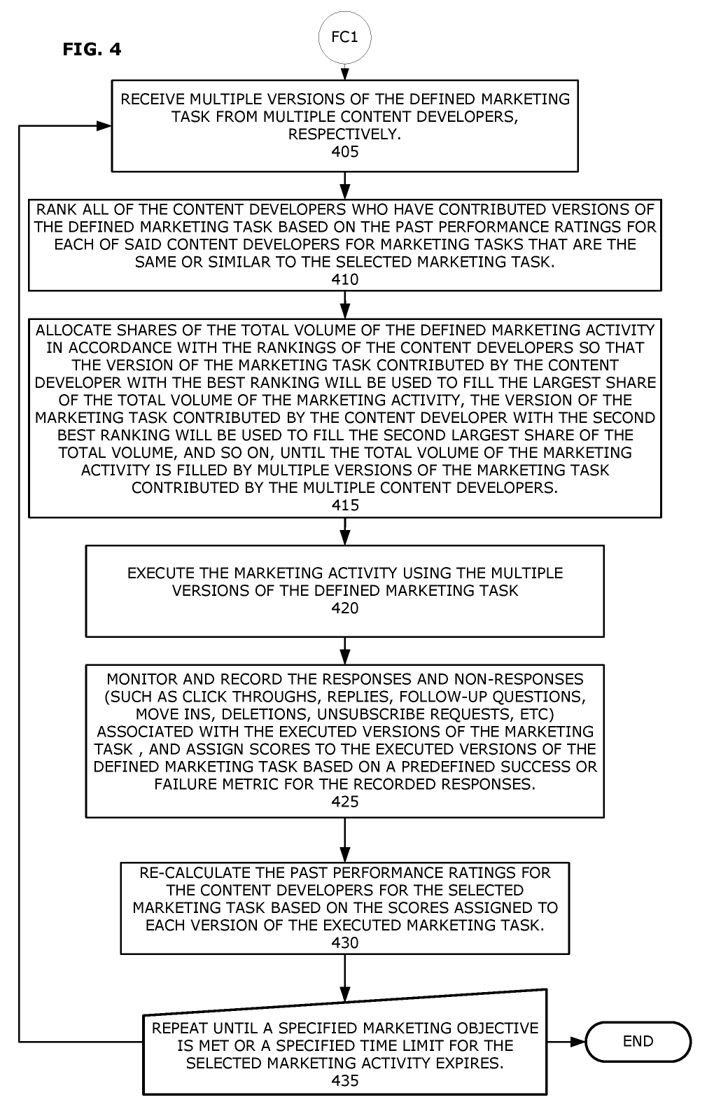

FIGS. 3 and 4 show a high-level flow diagram illustrating by way of example the steps performed in one implementation of the invention, such as the computer implementation depicted in FIG. 2, wherein the business is a senior living community and the shares of the total volume of the market activity are allocated in accordance with a defined set of percentage portions provided by the senior living community or system operator. However, it is understood and will be recognized by those skilled in the art that the steps shown in FIGS. 3 and 4, and described herein, may be carried out by the system for the benefit of any business or type of business engaged in marketing campaigns, marketing activities, and/or creating or receiving marketing tasks from content developers.

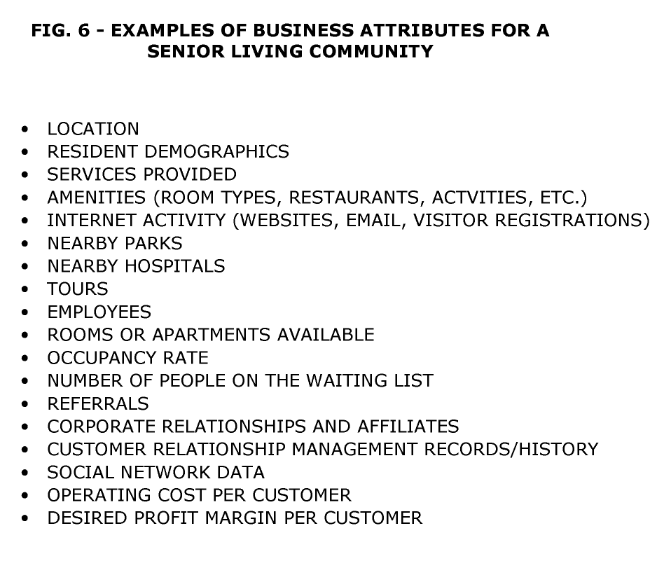

As shown in FIG. 3 at step 305, the system first receives and stores business information in a business information dataset, the business information comprising information about a senior living community and a set of community attributes for the senior living community. Examples of community attributes for the senior living community, which are listed in FIG. 6, may include attributes such as the senior living community's location, resident demographics, services and amenities, nearby parks, hospitals, operating cost per resident, occupancy rate, etc. Next, as shown in step 310 of FIG. 3, the system receives and stores information about a marketing activity for the senior living community, such as sending out a collection of marketing emails promoting the amenities of the senior living community. The information about the marketing activity specifies a total volume for the marketing activity, such as 2000 emails, as well as at least one marketing task that is associated with executing, carrying out or completing the marketing activity. So, for example, if one of the community attributes for the senior living community is a restaurant amenity for the senior living community, then examples of the marketing tasks may include, for instance, the tasks of creating an email message promoting the restaurant, creating a subject line for the email, taking a photo of customers enjoying a meal in the restaurant, building a webpage showing the restaurant's menu, creating a hyperlink to the webpage to embed in the email, and so on, so that the email with the subject line, photo and hyperlink may be used by the system to execute the marketing activity of sending out a total volume of 2000 emails to a collection of potential residents promoting the restaurant. The information about the marketing activity may also specify a time frame (or time limit) in which the marketing activity should be executed. Alternatively, the system may be configured to permit the business operator or system operator to begin or terminate the execution of the marketing activity at will.

The system next receives and stores in a content developer dataset information about a plurality of content developers, including for example, contact information and skills information about the content developer. See step 315. At step 320, the system calculates and stores in the content developer data set a past performance rating for each content developer for a previously executed marketing task that is the same as or like (i.e., in the same class as) the current marketing task for the current marketing activity. Preferably, the previously executed marketing task was executed by the content developer on behalf of the senior living community, or on behalf of one or more other senior living communities having community attributes that are the same as or similar to the community attributes of the senior living community. Next, at step 325, the system transmits to a plurality of content developers who have their contact information stored in the content developer dataset a request for each content developer to submit their own versions of the marketing task.

Processing then continues at step 405 of FIG. 4 by way of flow chart connectors FC1, wherein the system receives multiple versions of the selected marketing task from multiple content developers, respectively. The multiple versions of the marketing task from the multiple content developers are stored in a marketing task versions dataset on the system. In step 410, for all the content developers who have contributed versions of the marketing task, the system ranks those content developers based on the past performance ratings for each one of the contributing content developers for previously executed marketing tasks that are the same as or similar to the current defined marketing task. At step 415, the system then allocates shares of the total volume of the selected marketing activity, in accordance with the rankings of the content developers, so that the version of the marketing task contributed by the content developer with the best ranking will be used to fill the largest share of the total volume of the marketing activity, and the version of the marketing task contributed by the content developer with the second best ranking will be used to fill the second largest share of the total volume, and so on, until the total volume of the marketing activity is filled by multiple versions of the marketing task contributed by the multiple content developers. The system then executes the marketing activity (i.e., sends out the emails to a collection of potential customers) with multiple versions of the marketing task. Step 420.

As shown in step 425 of FIG. 4, the system is configured to monitor and record the responses and non-responses (such as click-throughs, replies, follow-up questions, move-ins, purchases, etc.) associated with the executed versions of the marketing task, and assigns scores to the executed versions of the marketing task based on a predefined success or failure metric for the recorded responses. For example, if a content developer's version of the marketing task fails to generate any positive responses, then the system will assign a very low score to that version of the marketing task. If, on the other hand, the content developer's version of the marketing task generates a positive response (such as a potential customer filling out an online form, visiting a webpage, requesting additional information, forwarding the email to a friend, or buying a product or service offered or described in the email), then that particular version of the marketing task will be assigned a score that is appropriately higher due to the favorable response. The scores are then used by the system to re-calculate the past performance ratings for the content developers who submitted versions of the marketing task, which produced the favorable responses. Step 430.

In preferred embodiments, the business info dataset or the marketing plan dataset containing marketing tasks also includes a specified marketing objective or a specified time limit for executing the marketing tasks. In alternative embodiments, the specified objective or time limit may be supplied by the business info source or the system operator. For example, if the business is a senior living community, then the specified marketing objective may comprise filing up all of the available rooms (i.e., 100% occupancy) and the specified time limit may comprise a period of one week. As shown in step 435, steps 405 through 430 may be carried out repeatedly until the specified marketing objective is met, or the specified time limit expires.

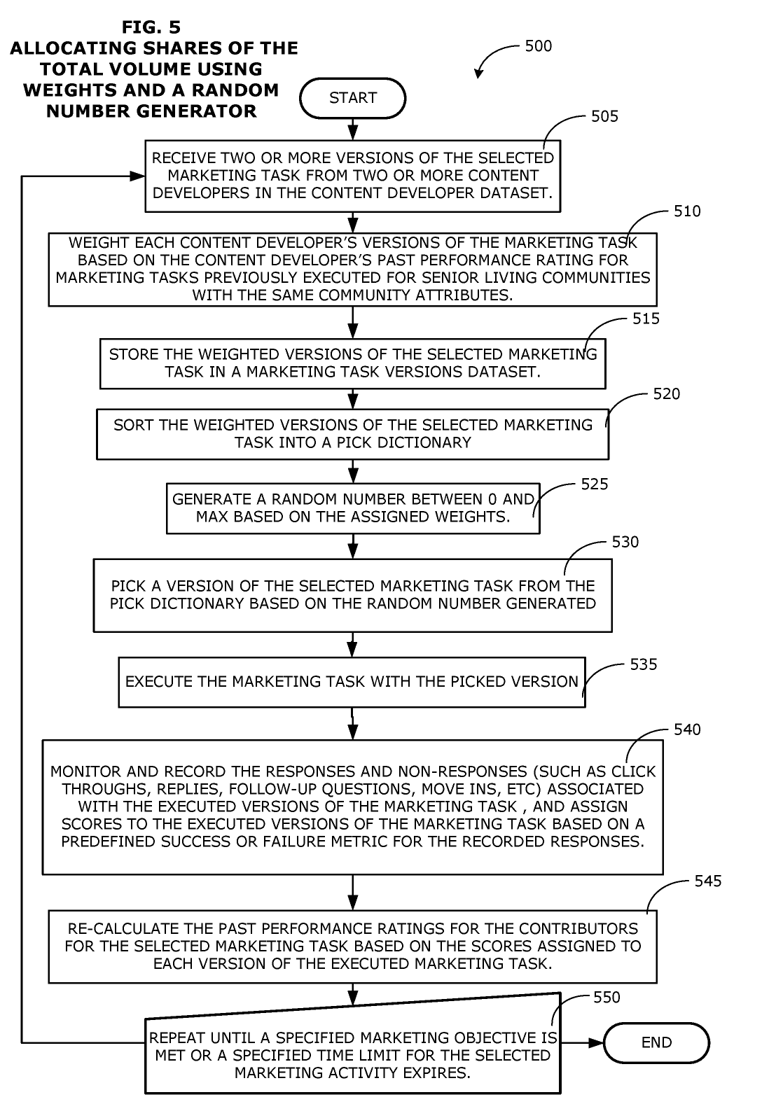

In some situations, it will be desirable or advantageous to permit the system to allocate the shares of the total volume for the marketing activity to content developers on a more random basis, based on a process that assigns weights to the contributed versions of the marketing tasks, wherein the weights are assigned in accordance with the past performance ratings of the content developers who contributed those marketing tasks. FIG. 5 shows a high-level flow diagram 500 illustrating by way of example the steps performed in an alternative implementation of the invention, wherein a random number generator is used to allocate and execute the multiple versions of a selected marketing task. As shown in FIG. 5 at step 505, the system first receives two or more versions of the selected marketing task from two or more content developers in the content developer dataset. Next, at step 510, the system weights each content developer's versions of the marketing task based on the content developer's past performance rating for marketing tasks previously executed for senior living communities with the same community attributes. Then the system stores the weighted versions of the selected marketing task in a marketing task versions dataset. Step 515. At steps 520, 525 and 530, the system sorts the weighted versions of the selected marketing task into a pick dictionary, generates a random number between 0 and a maximum value based on the assigned weights, and picks a version of the selected marketing task from the pick dictionary based on the random number generated. Thus, versions of the marketing task that have been contributed by content developers with better past performance ratings are statistically more likely to be picked and executed.

Next, in steps 535 and 540, the system executes the marketing task with the picked version, and then monitors and records the responses and non-responses associated with the executed versions of the marketing task. A multivariate testing engine calculates and assigns scores to the each version of the marketing task based on a predefined success or failure metric for the recorded responses for a multiplicity of factors, such as click-throughs, replies, follow-up questions, purchases of goods or services, online registrations, physical visits and website visits from potential customers that can be linked or traced back to each version of the marketing task. A response tracker is provided to monitor, track and tally these responses and non-responses. At steps 545 and 550, the system then re-calculates the past performance ratings for the content developers for the selected marketing task based on the scores assigned to each version of the executed marketing task, and then repeats steps 505 through 545 until a specified marketing objective is met or a specified time limit for the selected marketing activity expires.

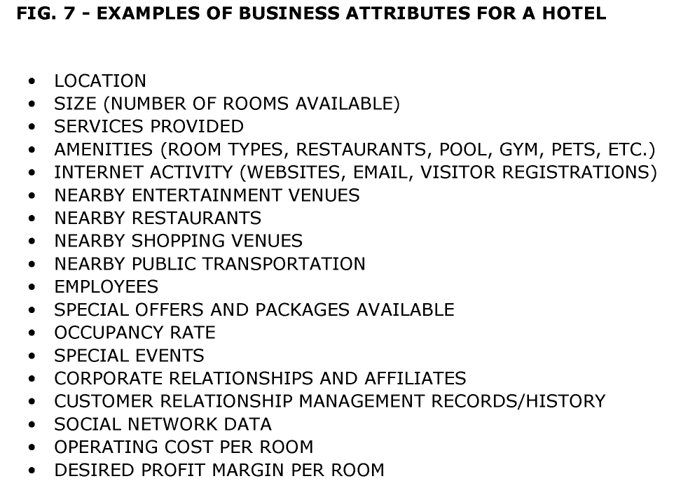

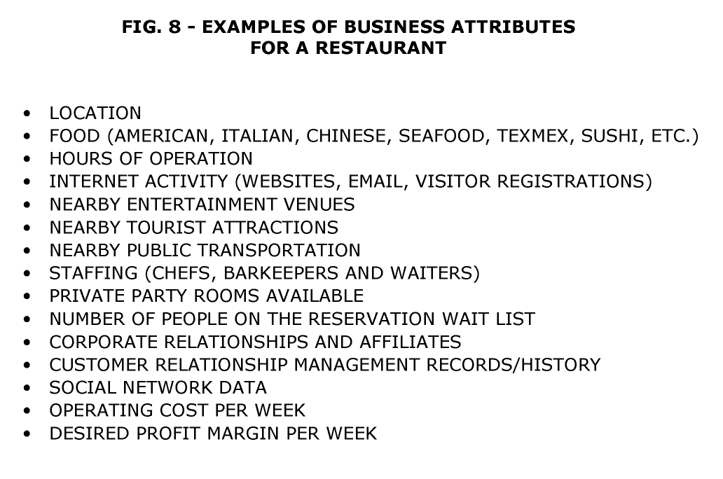

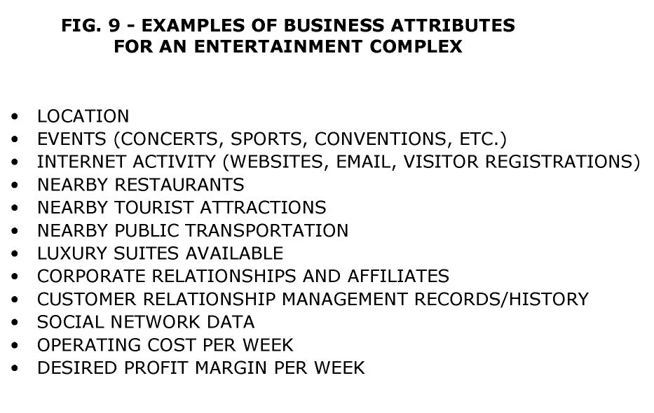

FIG. 7 shows examples of business attributes for a hotel in one implementation of the invention. FIG. 8 shows examples of business attributes for a restaurant in one implementation of the invention. FIG. 9 shows examples of business attributes for an entertainment complex in one implementation of the invention.

Although the invention has been described above in the context of a marketing task for an email-based marketing activity, it is understood that the invention may be beneficially applied to other types of marketing activities.

What is claimed is:

1. A system for selecting and testing marketing content for a business, comprising:
a) a microprocessor;
b) a memory storage area;
c) a business interface for receiving and storing a set of business attributes for the business;
d) a marketing plan dataset, in the memory storage area, comprising records defining a marketing objective and a marketing activity for a marketing plan, a total volume and a time limit for the marketing activity, a defined marketing task for the marketing activity, and a classification for the defined marketing task;
e) a content developer interface for receiving multiple versions of the defined marketing task submitted by multiple content developers, respectively;
f) a past performance calculator to calculate, for each content developer among said multiple content developers, a past performance rating for a previous marketing task having the same classification as said defined marketing task;
g) a leads interface for receiving and storing a collection of potential customer leads;
h) an execution module;
i) a response tracker; and
j) a multivariate scoring engine;
k) wherein the execution module, the response tracker and the multivariate scoring engine are operable with the microprocessor to cause the microprocessor to automatically
(i) rank the plurality of content developers who have submitted versions of the defined marketing task based on the past performance ratings for each content developer in said plurality of content developers,
(ii) allocate shares of the total volume of the defined marketing activity in accordance with the ranks of said multiple content developers,
(iii) execute the marketing activity against the collection of potential customer leads using said allocation of shares for the multiple versions of the defined marketing task,
(iv) track responses and non-responses to the executed marketing activity by the collection of customer leads,
(v) assign scores to the versions of the defined marketing task used to execute the marketing activity based on a predefined success or failure criterion for the responses and non-responses,
(vi) invoke the past performance calculator to re-calculate and adjust the past performance ratings for each content developer in the plurality of content developers based on the scores assigned to each version of the defined marketing task used in the execution of the marketing activity,
(vii) invoke the leads interface to modify the collection of potential customer leads, and
(viii) repeat steps (k)(i) through (k)(vii) until the specified marketing objective for the marketing plan is met or the specified time limit for the marketing activity expires.

2. The system of claim 1, wherein the execution module is operable with the microprocessor to allocate shares of the total volume of the defined marketing activity so that the largest share of the total volume of the marketing activity is filled by a version of the defined marketing task contributed by a content developer with the best ranking, and the second largest share of the total volume of the marketing activity will be filled by a version of the defined marketing task contributed by a content developer with the second best ranking.

3. The system of claim 1, wherein:
a) the system further comprises a random number generator; and
b) the execution module is operable with the microprocessor to allocate the shares by
(i) assigning weights to the versions of the defined marketing tasks in accordance with the rankings of the plurality of content developers,
(ii) populating a pick dictionary with the versions of the defined marketing tasks in accordance with the assigned weights, and
(iii) using a random number generated by the random number generator to select for execution one or more of the weighted versions of the defined marketing tasks in the pick dictionary;
c) whereby, over multiple executions of the marketing activity, a defined marketing task contributed by a content developer having the best past performance rating is more likely to have his or her version of the defined marketing task selected for execution more times than a content developer having a relatively lower past performance rating.

4. The system of claim 1, wherein:
a) the records in the marketing plan specify a marketing channel for executing the marketing activity; and
b) the system further comprises a marketing channel interface configured to direct the execution of the marketing activity to the specified marketing channel.

5. The system of claim 1, wherein the response tracker tracks and records, for each version of the defined marketing task:
a) a tally of positive responses received in response to said each version of the defined marketing task, or
b) a tally of negative responses received in response to said each version of the defined marketing task, or
c) a tally of non-responses for said each version of the defined marketing task, or
d) a tally of mouse clicks on an element of said each version of the defined marketing task, or
e) a tally of customer inquiries received in response to said each version of the defined marketing task, or
f) a tally of website visits attributable to said each version of the defined marketing task, or
g) a tally of registration forms received from potential customers in response to said each version of the defined marketing task, or
h) a tally of physical visits by potential customers attributable to said each version of the defined marketing task, or
i) a tally of product or service orders received in response to said each version of the defined marketing task, or
j) a tally of requests to be added to a distribution list in response to said each version of the defined marketing task, or
k) a tally of requests to be removed from a distribution list in response to said each version of the defined marketing task, or
l) a tally of social media platform likes received in response to said each version of the defined marketing task, or
m) a tally of email messages received in response to said each version of the defined marketing task, or
n) a tally of telephone calls received in response to said each version of the defined marketing task, or
o) any combination of two or more of the tallies described in this claim.

6. The system of claim 5, wherein the multivariate scoring engine calculates and assigns scores to each version of the defined marketing task based on the tallies tracked and recorded by the response tracker and the predefined success or failure criterion.

7. A method for selecting and testing marketing content for a marketing plan using a microprocessor and a memory storage area, the method comprising the steps of:
a) receiving and storing in the memory storage area a set of business attributes for the business;
b) storing in the memory storage area records defining a marketing objective and a marketing activity for the marketing plan, a total volume and a time limit for the marketing activity, a defined marketing task for the marketing activity, and a classification for the defined marketing task;
c) receiving and storing in the memory storage area multiple versions of the defined marketing task submitted by multiple content developers, respectively;
d) calculating with the microprocessor, for each content developer among said multiple content developers, a past performance rating for a previous marketing task having the same classification as said defined marketing task;
e) receiving and storing in the memory storage area a collection of potential customer leads;
f) with the microprocessor, ranking the plurality of content developers who have submitted versions of the defined marketing task based on the past performance ratings for each content developer in said plurality of content developers;
g) with the microprocessor, allocating shares of the total volume of the defined marketing activity in accordance with the rankings for said multiple content developers;
h) with the microprocessor, causing the marketing activity to be executed against the collection of customer leads using said allocation of shares for the multiple versions of the defined marketing task;
i) with the microprocessor, tracking and recording in the memory storage area responses and non-responses to the executed marketing activity by potential customers in the collection of customer leads;
j) with the microprocessor, assigning scores to each version of the defined marketing task used to execute the marketing activity based on a predefined success or failure criterion,
k) with the microprocessor, modifying the past performance ratings for each content developer in the plurality of content developers based on the scores assigned to each version of the defined marketing task used in the execution of the marketing activity,
l) with the microprocessor, modifying the collection of potential customer leads, and
m) repeating steps (f) through (l) until the specified marketing objective for the marketing plan is met or the specified time limit for the marketing activity expires.

8. The method of claim 7, further comprising the step of allocating the shares of the total volume of the defined marketing activity so that the largest share of the total volume of the marketing activity is filled by a version of the defined marketing task contributed by a content developer with the best ranking, and the second largest share of the total volume of the marketing activity will be filled by a version of the defined marketing task contributed by a content developer with the second best ranking.

9. The method of claim 7, further comprising:
a) assigning weights to the versions of the defined marketing tasks in accordance with the rankings of the plurality of content developers,
b) populating a pick dictionary with the versions of the defined marketing tasks in accordance with the assigned weights, and
c) using a random number generator to select for execution one or more of the weighted versions of the defined marketing tasks in the pick dictionary;
d) whereby, over multiple executions of the marketing activity, a defined marketing task contributed by a content developer having the best past performance rating is more likely to have his or her version of the defined marketing task selected for execution more times than a content developer having a relatively lower past performance rating.

10. The method of claim 7, further comprising the steps of:
a) specifying a marketing channel for executing the marketing activity; and
b) with the microprocessor, causing the execution of the marketing activity to the specified marketing channel.

11. The method of claim 7, further comprising tracking and recording, for each version of the defined marketing task:
a) a tally of positive responses received in response to said each version of the defined marketing task, or
b) a tally of negative responses received in response to said each version of the defined marketing task, or
c) a tally of non-responses for said each version of the defined marketing task, or
d) a tally of mouse clicks on an element of said each version of the defined marketing task, or
e) a tally of customer inquiries received in response to said each version of the defined marketing task, or
f) a tally of website visits attributable to said each version of the defined marketing task, or
g) a tally of registration forms received from potential customers in response to said each version of the defined marketing task, or
h) a tally of physical visits by potential customers attributable to said each version of the defined marketing task, or
i) a tally of product or service orders received in response to said each version of the defined marketing task, or
j) a tally of requests to be added to a distribution list in response to said each version of the defined marketing task, or
k) a tally of requests to be removed from a distribution list in response to said each version of the defined marketing task, or
l) a tally of social media platform likes received in response to said each version of the defined marketing task, or
m) a tally of email messages received in response to said each version of the defined marketing task, or
n) a tally of telephone calls received in response to said each version of the defined marketing task, or
o) any combination of two or more of the tallies described in this claim.

12. The method of claim 11, further comprising calculating and assigning scores to each version of the defined marketing task based on the tallies and the predefined success or failure criterion.
